(19) United States
(12) Patent Application Publication
(10) Pub. No.: US 2026/0269693 A1
(43) Pub. Date: Sep. 10, 2026

(54) CONDUCTIVE BRUSH

(71) Applicant: AKTIEBOLAGET SKF, GOTEBORG (SE)

(72) Inventors: Emmanuel BENEVISE, Monts (FR); Mickael CHOLLET, Joué-Lès-Tours (FR); Nicolas ANDRE, Ballan-Miré (FR); Anthony SIMONIN, Tours (FR)

(21) Appl. No.: 19/551,782

(22) Filed: Feb. 27, 2026

(30) Foreign Application Priority Data
Mar. 7, 2025 (DE) 102025108644.3

(51) Int. Cl. H02K 11/40

(52) U.S. Cl. CPC H02K 11/40

(57) ABSTRACT

A conductive brush for diverting electric current from a rotating part and a non-rotating part includes an annular base element arranged on the non-rotating part or on the rotating part, an electrically conductive element, and at least one holding element arranged on the annular base element for holding the electrically conductive element. The electrically conductive element is made of an electrically conductive, flexible material, and is arranged to be in contact with both the rotating part and the non-rotating part.

### CROSS-REFERENCE

This application claims priority to German patent application no. 102025108644.3 filed on March 7, 2025, the contents of which are fully incorporated herein by reference.

### BACKGROUND OF THE INVENTION

The present invention relates to a conductive brush for diverting an electric current between a rotating part and a non-rotating part.

In the design of electric motors or rotor/stator arrangements, it is common to use bearings, for example rolling bearings, to support a shaft in a housing. Voltage on the shaft induces current flow through the shaft bearings to the housing and then the ground. While the motor or rotor is running, the bearings become more resistive to current flow, causing a buildup of charge on the shaft surfaces. Over a short period of time, the voltage may cause electrical charges to build up to a high level. As the electrical charges pass the threshold level of the least electrically resistant path, usually through the rolling bearings on the shaft, an instantaneous burst or discharge of electric current passes through the bearing.

Such a discharge may cause damage in the bearing, for example on the surfaces of bearing raceways and rolling elements. These damages may be for example fusion craters, and particles or debris from the crater formation may remain inside the bearing and may have an impact on the functionality of the bearing, for instance by influencing a sealing of the bearing. Further, both the fusion crater and the particles in the bearing may disturb the free rotation of the bearing, which can lead to physical damage and premature bearing failure. This may lead to premature wear and corresponding damages of different parts of the arrangement and thus to a reduced service life of the whole arrangement, for example an electric motor or rotor/stator arrangement.

In order to reduce damage caused by electric currents, electric currents may be conveyed via conductive elements within the arrangement. Thus, typically a defined electrical path between a rotating and a non-rotating path of an arrangement or application is provided. Known solutions for establishing such an electrical path provide a contact between the rotating and non-rotating part. However, such solutions use complex components which are integrated into the arrangement for establishing the electrical contact and divert currents, and thus involve high manufacturing and assembly costs.

It is therefore object of the present invention to provide a solution for establishing an electrical contact between a rotating and a non-rotating part, such as a shaft and a housing, which is cost-efficient and can be easily mounted.

### SUMMARY OF THE INVENTION

The above object of the present invention is solved by a conductive brush for diverting an electric current between a rotating part and a non-rotating part, the conductive brush comprising an annular base element arrangeable on the non-rotating part or at the rotating part, an electrically conductive element, and at least one holding element arranged on the annular base element and configured to hold the electrically conductive element. The electrically conductive element is made of an electrically conductive, flexible material and is arranged to be in contact with both the rotating part and the non-rotating part.

The conductive brush is configured to divert an electric current, or more general electricity, between a rotating part and a non-rotating part, for example a shaft and a housing. For instance, in an electric motor or a stator/rotor arrangement, electricity is present which may result in electric currents across the components of the motor or arrangement, for example a bearing supporting a shaft within a housing. Typically, these components are not adapted to withstand such (high) electric currents and may thus experience damage over time.

In order to avoid damage of the components within an arrangement comprising a rotating and a non-rotating part, the herein described conductive brush may be used for diverting electric currents from the rotating to the non-rotating part and vice versa. The conductive brush is designed to be easily mounted in a cost efficient way. For this, the conductive brush comprises an annular base element configured to be arranged at the non-rotating part or rotating part, an electrically conductive element, and at least one holding element, which is arranged at the annular base element and is configured to hold the electrically conductive element. The electrically conductive element is made of an electrically conductive, flexible material, and is arranged to be in contact with the rotating part and the non-rotating part. Thus, the electrically conductive element is able to divert electric currents from the rotating part to the non-rotating part and vice versa so that these electric currents will not be diverted through a bearing or other components arranged between the rotating and the non-rotating part, thus effectively reducing damage caused by electric currents.

The proposed conductive brush minimizes the number of required parts, making it simpler and more cost-effective to manufacture and assemble compared to traditional solutions. It furthermore improves electrical contact. In particular the use of the electrically conductive element ensures a reliable electrical contact between the rotating and non-rotating parts. The conductive brush effectively diverts stray currents, reducing wear and preventing electrical damage to components, as described above.

Further, due to the annular base element, the conductive brush may be easily integrated into existing systems without extensive modifications. The annular base element may further be flexibly adapted in size to be integrated into various applications. The conductive brush is furthermore applicable to various systems, especially electric and hybrid vehicles, where diverting stray currents may be critical.

According to an embodiment, the electrically conductive element comprises fibers, preferably carbon fibers. This material choice may offer advantages in terms of both electrical conductivity and flexibility, ensuring that the electrically conductive element can maintain contact with both parts, the rotating and non-rotating part, even during a relative motion without a risk of breaking. Preferably, the electrically conductive element comprises a plurality of fibers.

Furthermore, the fibers may be made of carbon resulting in very light and thin fibers. Further, the fibers can be fibers coated with metals like silver, copper, nickel, or gold. These fibers can have a composite with a non-metallic core (e.g., polyester, nylon, or glass) with a thin layer of metal applied via electroplating, sputtering, or vapor deposition. The fibers can also be conductive polymer fibers, like polyaniline (PANI), polypyrrole (PPy) or poly(3,4-ethylenedioxythiophene) polystyrene sulfonate (PEDOT:PPS). These fibers can be made of entirely conductive polymers or a polymer base blended with conductive additives. Such fibers are lightweight and highly flexible, have a tunable conductivity based on their material composition, and the usage of non-metallic fibers may reduce the risk of corrosion. The fibers can also be graphene-based fibers, where graphene or graphene oxide is embedded into the fibers or is used as a coating. This may provide the advantage that such fibers have a high electrical and thermal conductivity, are lightweight and have mechanical strength.

According to a further embodiment, the at least one holding element is a snap connection element (e.g., a clip or snap hook), used to secure the electrically conductive element in place at the annular base element. This can simplify the assembly and ensure the stable position of the conductive element during operation. Such a snap connection element may be advantageous as the electrically conductive element may be easily removed and replaced, for example in case of damage or wear of the electrically conductive element.

The holding element can also consist of magnetic components, such as permanent magnets or electromagnets, integrated into the annular base element to secure the electrically conductive element. This may also provide the advantage of an easy assembly and disassembly, as it allows a tool free attachment and removal of the electrically conductive element. Furthermore, it is non-intrusive, as it eliminates the need for physical fasteners that could damage the conductive element. Further, such a holding element is durable, as it may resist vibrations and mechanical wear over time.

The holding element could also be a sliding groove mechanism. A sliding groove or rail integrated into the annular base element allows the conductive element to be slotted and locked into position. This may have the advantage of an ease of use, as it provides a quick installation and removal without tools. Further, a sliding groove mechanism enhances the stability of the brush as the groove provides mechanical support to prevent lateral movement.

Furthermore, the holding element, in particular in the form of a snap connection element, may be a spring-clamp mechanism. A spring-loaded clamp may hold hereby the conductive element securely against the annular base element. Using such a holding element, an automatic adjustment may be achieved as the spring mechanism may adapt to small variations in size or shape of the conductive element. Further, a quick installation (as the setup is fast and tool-free) and a shock absorption (as it reduces stress on the conductive element caused by vibrations) may be achieved.

According to a further embodiment, the at least one holding element can be clamped or pressed into the annular base element. This allows the conductive element to be securely attached to the annular base element via the holding element, ensuring a firm connection that further supports the electrical functionality. Further options for securing the holding element to the annular base element could include one or more of the following: laser welding, ultrasonic welding, injection molding, adhesive bonding, 3D printing, and additive manufacturing.

Laser welding could be employed to attach the holding element to the annular base element. This option offers several advantages including high precision, minimal thermal distortion, and a strong, permanent connection. It may be particularly suitable for applications requiring robust and durable joints, especially in environments subject to high stress or vibration.

Another option is ultrasonic welding, which uses high-frequency vibration to create a bond between the holding element and the base element. This attachment option may be advantageous because it produces a clean and fast bond without the need for additional adhesives or fasteners. It is also highly efficient and ideal for connecting lightweight or thermoplastic components.

Injection molding could be utilized to directly form the holding element as an integral part of the annular base element. This process may enable seamless integration, reduce the number of separate components, and enhance the overall structural integrity. It may also offer cost-efficiency for large-scale production and may allow for complex shapes to be achieved in a single step.

Further, adhesive bonding could be considered, where a high-strength industrial adhesive is used to affix the holding element to the base element. This approach may provide flexibility in material choice, create a smooth surface finish, and absorb vibrations effectively, making it suitable for applications sensitive to mechanical stress.

Finally, 3D printing or additive manufacturing could be employed to produce both the annular base element and the holding element as a single, unified structure. This approach may allow highly customized and complex designs, rapid prototyping, and minimal material waste, making it ideal for innovative or low-volume production runs.

According to a further embodiment, the at least one holding element is arranged within a recess, in particular a hole, in the annular base element. For example, the holding element may be made by injecting a polymer, wherein the injected polymer may pass through such an opening or hole in the annular base element. This design may offer manufacturing flexibility and can reduce production costs by minimizing the number of individual parts needed for assembly. Further, metal injection molding (MIM) for the holding element could be used. This process involves injecting a powdered metal-polymer mixture into a mold, followed by debinding and sintering to create a fully metal component. This technique may allow for precise and complex geometries while providing the mechanical strength and durability of metal. It may be particularly suitable for applications requiring high performance under mechanical stress or heat.

Another possibility is thermoplastic elastomers (TPE) as the material for the holding element. These materials may combine the elasticity of rubber with the processability of plastics. A holding element made from TPE can be directly overmolded onto the annular base element, ensuring a secure fit with excellent vibration and shock absorption properties. This approach is cost-effective and ideal for scenarios requiring flexibility and resilience.

Overmolding using a two-material injection process is another option. In this case, the holding element may be formed by injecting a secondary polymer directly into the annular base element, which has already been pre-molded in a primary material. This creates a strong bond between the components while reducing assembly steps and ensuring a cohesive structure. Overmolding may also allow the use of different materials for the base and holding element, optimizing their respective properties. For increased strength and thermal stability, the holding element may be fabricated from fiber-reinforced polymers (FRPs). These materials, incorporating carbon or glass fibers, may offer enhanced mechanical properties while remaining lightweight. Fiber-reinforced polymers may be particularly advantageous for high-stress or high-temperature applications and can be shaped using techniques like injection molding or compression molding.

Die casting could also be employed to produce the holding element from metals like aluminum or zinc alloys. This approach may enable high-precision production of complex shapes with excellent surface finishes. Die-cast metal components are highly durable, offering excellent resistance to wear and deformation, making them suitable for demanding operational environments.

According to a further embodiment, the annular base element may specifically be formed as a snap ring. For example, the snap ring may be made of an electrically conductive material, preferably steel, but may alternatively be made of aluminum, copper, a conductive polymer or any other appropriate material capable of functioning as a snap ring. Forming the snap ring of a conductive material contributes to the overall electrical conductivity of the conductive brush, further improving its efficiency in diverting current between the rotating and non-rotating parts through the conductive brush and preventing such current from passing through the bearing. The annular base element could also be designed as a spring-loaded ring. The spring-loaded design allows the base element to maintain consistent contact with the rotating or non-rotating part and other components, even under mechanical vibrations or thermal expansion, thereby enhancing operational reliability.

The annular base element may also be made from a beryllium-copper alloy, which provides excellent electrical conductivity while providing superior mechanical flexibility and resilience, or from nickel-plated steel, which may provide a lightweight and cost-effective component with excellent surface conductivity and corrosion resistance. Nickel plating further protects the steel from wear and environmental degradation, ensuring long-term durability in challenging conditions.

Alternatively, the annular base element may be made from conductive polymers, such as carbon-filled thermoplastics, which provide adequate electrical conductivity while significantly reducing the overall weight of the component. Conductive polymers are also corrosion-resistant and can be shaped using injection molding, making them ideal for applications where weight reduction and cost efficiency are priorities. Die-cast aluminum could be another material usable for the annular base element. This material offers a good balance of electrical conductivity, lightweight properties, and structural strength. Die-casting allows for complex geometries and tight tolerances, making it suitable for high-precision applications. Additionally, the annular base element may be made of aluminum being naturally corrosion-resistant, further enhancing the durability of the base element.

To improve adaptability and performance, the annular base element could be manufactured using laminated composites. These composites consist of alternating layers of conductive and insulating materials, which can provide a controlled flow of electric current while maintaining mechanical stability. Laminated designs are particularly advantageous in environments requiring fine-tuned electrical performance or where electrical isolation is partially necessary.

According to a further embodiment, the snap ring includes a tool holding or engagement portion. The tool holding/engagement portion enables a tool to expand or compress the snap ring during assembly in or on the rotating or non-rotating part. Thus, the interaction of the tool and the tool holding portion enables easy installation and maintenance of the snap ring, and thereby the entire conductive brush. The tool holding portion may, for example, comprise openings in the snap ring in which the tool may engage. Alternatively, the tool holding or engagement portion may include threaded elements or inserts, for example made of stainless steel or brass. These elements or inserts may allow for the attachment of auxiliary tools or accessories, such as grounding leads or positioning brackets. Threaded inserts may provide a durable and reliable connection point while offering resistance to mechanical stress and corrosion. Another option may be magnetic tool holders attached to the snap ring at the tool holding portion. For example, small permanent magnets could be embedded in the snap ring and could securely hold tools or other components in place during installation or maintenance. Such magnetic holders may provide a convenient and non-invasive method for tool attachment and may be, for example, useful in environments where quick access is necessary.

In addition to an electric contact between the electrically conductive element and the rotating part as well as the non-rotating part, the electrically conductive element can also be electrically connected to the holding element. This may further improve the efficient diversion of electric currents between the rotating and non-rotating parts. In this case, the electrically conductive element should be attached to the holding element using an electrically conductive attachment, such as welding, attachment using conductive adhesives (e.g., containing silver, carbon, or copper particles), soldering (e.g., using low-resistance solder alloys, such as those containing silver, tin, or bismuth), mechanical crimping (e.g., the conductive element may be physically compressed into a slot or groove in the holding element), riveting (e.g., using rivets made from conductive materials, such as copper or aluminum, etc.), etc.

According to a further embodiment, a plurality of holding elements is arranged at the annular base element. Thus, a plurality of electrically conductive elements may be arranged at the annular base element using the plurality of holding elements. The holding elements, and thus the electrically conductive elements, can be evenly and/or unevenly distributed around the circumference of the annular base element. The holding elements may be designed as modular clip-on components that can be easily attached or detached from the annular base element. This modular design allows for customized configurations, enabling even or uneven arrangements based on specific application requirements. The clip-on mechanism simplifies installation and maintenance while ensuring a secure fit. Instead of adapting the number and distribution of the holding elements, it is also possible to not equip every holding element with an electrically conductive element, but only some of them. Thus, some holding elements may remain empty whereas others hold electrically conductive elements.

Another approach involves integrated rails or grooves on the annular base element, into which the holding elements can be slid and locked into position. This approach may provide high flexibility in placement, allowing precise adjustment of the layout of the conductive brush. Additionally, the sliding mechanism may ensure stability during operation while facilitating quick reconfiguration when needed. Finally, asymmetrical or adaptive layouts could be employed, where holding elements of different shapes, sizes, or materials are strategically placed based on the application's specific requirements. For example, larger, more robust holding elements can be positioned in areas experiencing higher mechanical loads, while smaller, lightweight holding elements can be used where precision and flexibility are paramount.

Further preferred embodiments are defined in the dependent claims as well as in the description and the figures. Thereby, elements described or shown in combination with other elements may be present alone or in combination with other elements without departing from the scope of protection.

### BRIEF DESCRIPTION OF THE SEVERAL VIEWS OF THE DRAWINGS

In the following, preferred embodiments of the invention are described in relation to the drawings, wherein the drawings are exemplary only, and are not intended to limit the scope of protection. The scope of protection is defined by the accompanied claims, only. The figures show:

FIG. 1 is a schematic view of a conductive brush for diverting an electric current in a front side view; and

FIG. 2 is a schematic view of the conductive brush of FIG. 1 arranged between a rotating part and a non-rotating part in cross-section.

### DETAILED DESCRIPTION OF THE INVENTION

In the following same or similar functioning elements are indicated with the same reference numerals.

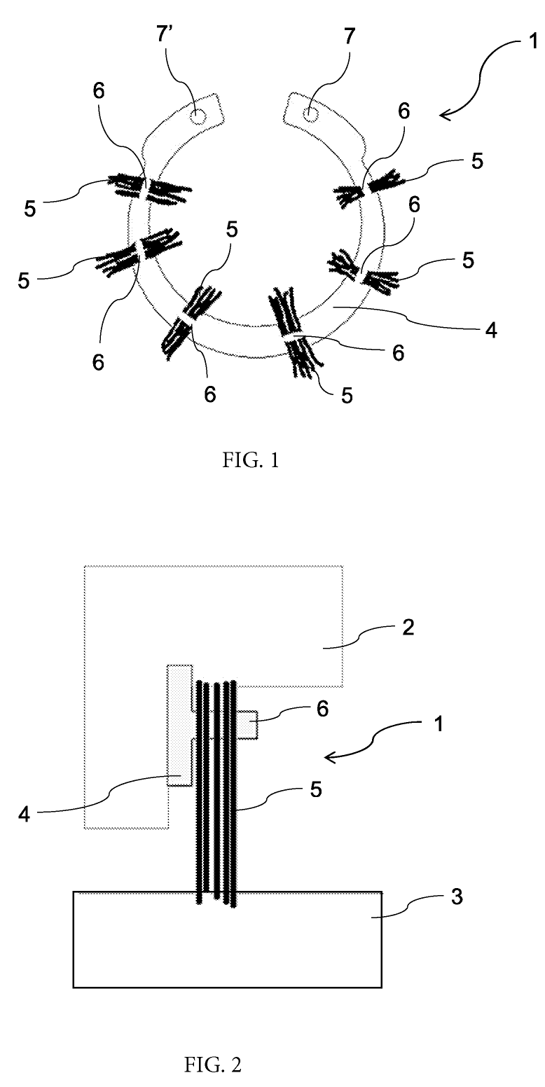

FIG. 1 shows a front view of a conductive brush 1 for diverting an electric current between a rotating part 3 and a non-rotating part 2 (which are shown and described in further detail in FIG. 2), thereby preventing such current from passing through a bearing and causing damage to the raceways or rolling elements thereof. The conductive brush 1 comprises an annular base element 4, here in form of an open (snap) ring. On the annular base element 4, electrically conductive elements 5 are attached by means of holding elements 6.

The holding elements 6, in the depicted example six holding elements 6, may be distributed around the circumference of the annular base element 4 in any manner, for example with even distances or even spacing, uneven distances or “staggered”, only on one side or in any other manner. The holding elements 6 may comprise a clamping mechanism for clamping and securely fixing the electrically conductive elements 5.

The electrically conductive elements 5 may be made of a flexible and conductive material, for instance fibers, which ensure a reliable contact between the rotating part 3 and the non-rotating part 2. In particular, one electrically conductive element 5 may consist of a plurality of fibers bundled together. As shown in FIG. 2, the fibers 5 are in simultaneous contact with both a non-rotating part 2, for example a housing, and with a non-rotating part 3, for example a shaft.

Furthermore, the conductive brush 1 comprises two tool holding or engagement portions 7, 7’, which are preferably in the form of two holes as depicted, arranged on the open ends of the annular base element 4 and are configured to receive a tool, for instance snap ring pliers. The tool may compress or expand the annular base element 4 so that the base element 4 may be inserted into a rotating or non-rotating part 3, 2 or may be arranged around a rotating or non-rotating part 3, 2.

FIG. 2 illustrates a side view of the conductive brush 1 according to FIG. 1 positioned between a rotating part 3 and a non-rotating part 2. The non-rotating part 2 may be a housing and the rotating part 3 may be a shaft. As already described above, the electrically conductive elements 5 maintain contact with both parts, the rotating part 3 and non-rotating part 2, during operation, thus effectively diverting an electric current and thus minimizing stray currents.

As explained above, the annular base element 4 is securely fixed to one of the parts, for example by inserting the annular base element 4 into a groove of the respective part, in this case the non-rotating part 2. This ensures a stable connection between the conductive brush 1, and thus the conductive elements 5, and the non-rotating part 2, even under operational stresses such as vibrations or thermal expansion. The arrangement offers several advantages, including reduced wear and prevention of electrical damage to components. The conductive brush 1 also allows for seamless integration into existing systems, making it highly versatile for applications, in particular in electric and hybrid vehicles, where efficient current management is critical. The durable and adaptable design further ensures reliable performance under challenging conditions, contributing to the overall longevity and efficiency of the system.

In summary, the herein described conductive brush provides a simple way for diverting an electric current between a rotating part and a non-rotating part, which ensures a stable contact between the conductive brush and the rotating or non-rotating part, and which comprises a simple design.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### REFERENCE NUMERALS

1 Conductive brush
2 Non-rotating part
3 Rotating part
4 Base element
5 Electrically conductive element
6 Holding element
7,7’ Tool engagement portion

We claim:

1. A conductive brush for diverting electric current between a rotating part and a non-rotating part, the conductive brush comprising:
an annular base element arrangeable on the non-rotating part or on the rotating part;
an electrically conductive element; and
at least one holding element arranged on the annular base element and configured to hold the electrically conductive element;
wherein the electrically conductive element is made of an electrically conductive, flexible material and is arranged to be in contact with both the rotating part and with the non-rotating part.

2. The conductive brush according to claim 1, wherein the electrically conductive element includes conductive fibers.

3. The conductive brush according to claim 2, wherein the conductive fibers are carbon fibers.

4. The conductive brush according to claim 1, wherein the at least one holding element is a snap connection element.

5. The conductive brush according to claim 4, wherein the snap connection element is a clip or a snap hook.

6. The conductive brush according to claim 4, wherein the holding element is clamped or pressed onto the annular base element.

7. The conductive brush according to claim 1, wherein the holding element is arranged within a recess in the annular base element.

8. The conductive brush according to claim 7, wherein the recess in the annular base element is a hole.

9. The conductive brush according to claim 1, wherein the annular base element is a snap ring.

10. The conductive brush according to claim 9, wherein the snap ring is made of an electrically conductive material.

11. The conductive brush according to claim 10, wherein the snap ring is made of steel.

12. The conductive brush according to claim 9, wherein the snap ring has at least one tool engagement portion.

13. The conductive brush according to claim 1, wherein the electrically conductive element is electrically conductively connected to the holding element.

14. The conductive brush according to claim 1, wherein a plurality of holding elements are arranged on the annular base element.
